(19) United States
(12) Patent Application Publication
(10) Pub. No.: US 2008/0136921 A1
(43) Pub. Date: Jun. 12, 2008

(54) Captive Universe: a 26 Viewpoint Method to Contain Infinity

(76) Inventor: Gregory Michael Hernandez, Sylmar, CA (US)

Correspondence Address: Gregory Michael Hernandez, 15455 Glenoaks Blvd., #230, Sylmar, CA, 91342, US

(21) Appl. No.: 11/609,386

(22) Filed: Dec. 12, 2006

(51) Int. Cl. H04N 9/04; H04N 5/225

(52) U.S. Cl. 348/207.99

(57) ABSTRACT

In the fields of art and photography there is a new process. It allows the entire realm of vision from any particular location to be captured by photograph, and held in the palm of your hand like a globe of the entire universe. This process is called “The Captive Universe: a 26 Viewpoint Method to Contain Infinity”. By using a 26 sided object called a Truncated Cuboctahedron, the inventor can take 26 precise photographs in landscapes, architectural monuments, and other awe inspiring locations. Upon developing the film, the photos are cut into exact shapes and assembled into a flat or three-dimensional version of the Truncated Cuboctahedron. When finished, the entire realm of vision, from “here” to infinity, is on the surface yet the eye looks “into” the images. When rotated, the images flow from shape to shape, and every corner and angle can be inspected and explored.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention pertains to the fields of art and photography. There are many common methods to photograph and display a 360 degree landscape, or the entire realm of vision from one location, but this method is unique and new.

### BRIEF SUMMARY OF THE INVENTION

The object of this invention is to be able to photograph the entire realm of vision from any particular location. Using Archimedes' 26 sided solid called the “Truncated Cuboctahedron” (also called the “Great Rhombicuboctahedron”) as a guide, this invention is the process to take 26 precise photographs, and assemble them into a three dimensional shape which allows the viewer to hold and observe the entire realm of vision. The object may be displayed as a work of art in itself, the photographs may be displayed in a flattened version as a work of art in itself, and the inventive process lends itself to other artistic expressions, which I will attempt to explore in the future.

### BRIEF DESCRIPTION OF THE SEVERAL VIEWS OF THE DRAWING

FIG. 1: This is a drawing of the “Truncated Cuboctahedron”, also called the “Great Rhombicuboctahedron”. A well known Archimedean Solid, it has 26 faces; 12 regular square faces, 8 regular hexagonal faces, and 6 regular octagonal faces.

FIG. 2: This is the same Truncated Cuboctahedron, but from a different angle. The sides are clear, thus enabling the viewer to see the edges on the other side (depicted with thinner lines).

FIG. 3: This is a drawing of the net of a Truncated Cuboctahedron, meaning it is a flat, edge-joined arrangement of the 26 faces which can be folded to create the three dimensional Truncated Cuboctahedron. I have designated each shape with a letter.

FIG. 4: In the center of this Truncated Cuboctahedron, is a camera, depicted as a cube with a circle for a lens. It is resting on a tripod, which is depicted with three lines extending down and dots for feet. The three x's mark the center of three octagonal sides, and extend directly to the camera, thus illustrating that the camera is exactly in the middle of this three dimensional shape.

FIG. 5: This is a side view of the Truncated Cuboctahedron. The camera (in the center) is level and pointed straight to the left, the direction of which is called “North”. The dotted lines represent the throw of the camera lens, which hits the top and bottom of the octagon facing north, of which this view depicts as a single line. The camera lens is shown to have a vertical throw of approximately 66 degrees.

FIG. 6: This is an aerial view illustrating the direction of the first 8 photos, which are labeled A, B, C, D, E, F, G and H (see FIG. 3). The 8 sided shape drawn with thick lines is the outside perimeter of the Truncated Cuboctahedron (viewed from above). The circle in the center represents the camera. The dotted lines indicate the view from the camera towards the following 8 directions: A, C, E, and G are photos taken in the four easterly directions: north, east, south, and west. Respectively, these photos are capturing the field of vision beyond Octagons A, C, E, and G (FIG. 3). B, D, F, and H are photos taken in between the previous four directions, namely: northeast (NE), southeast (SE), southwest (SW), and northwest (NW). Respectively, they are capturing the field of vision beyond Squares B, D, F and H (FIG. 3).

FIG. 7: This is an aerial view of the Truncated Cuboctahedron, showing the location of the next 8 photos, which are labeled I, J, K, L, M, N, O and P. The circle in the center is the camera. The direction of these 8 photos are depicted with the arrows pointing to the North, NE, East, SE, South, SW, West, and NW.

FIG. 8: This is the opposite of an aerial view: it is the view as if one were underground looking up at the Truncated Cuboctahedron and camera. The circle in the center represents the camera. The direction of these 8 photos are depicted with arrows pointing to the North, NE, East, SE, South, SW, West, and NW.

FIG. 9: This is a side view of the Truncated Cuboctahedron, and the camera on the tripod is illustrated in the center. The camera is shown pointing directly up (towards Octagon Y), and the throw of the lens is opened to approximately 66 degrees, indicated by the dotted lines.

FIG. 10: This is a side view of the Truncated Cuboctahedron, and the camera is illustrated in the center. The camera is shown pointing directly down (towards Octagon Z), and the throw of the lens is opened to approximately 66 degrees, indicated by the dotted lines.

FIG. 11: This illustration shows 26 photographs (indicated by the solid lines) when developed at 4 inches by 6 inches. They are placed in order, designated A through Z. The dotted lines indicate how each photograph is to be cut into its corresponding shape. There are 12 squares, 8 hexagons, and 6 octagons. Every side of every shape must have an equal length.

FIG. 12: This illustrates the 26 photos after being out. They have been laid face up in the formation of the net Truncated Cuboctahedron (FIG. 3). The letters in each shape refer to the corresponding photos in FIG. 11, and the dot in each shape indicates the “up” direction of each photo.

FIG. 13: This depicts all the photos from FIG. 12 taped together to form the full three dimensional Truncated Cuboctahedron. When the photo images are facing out, the entire realm of vision can be observed on the outside of the solid shape. I have illustrated this by drawing what a simple desert road might look like if one were standing in the middle of it. The upper half of the shape would be the sky, and the lower half would be the ground.

### DETAILED DESCRIPTION OF THE INVENTION

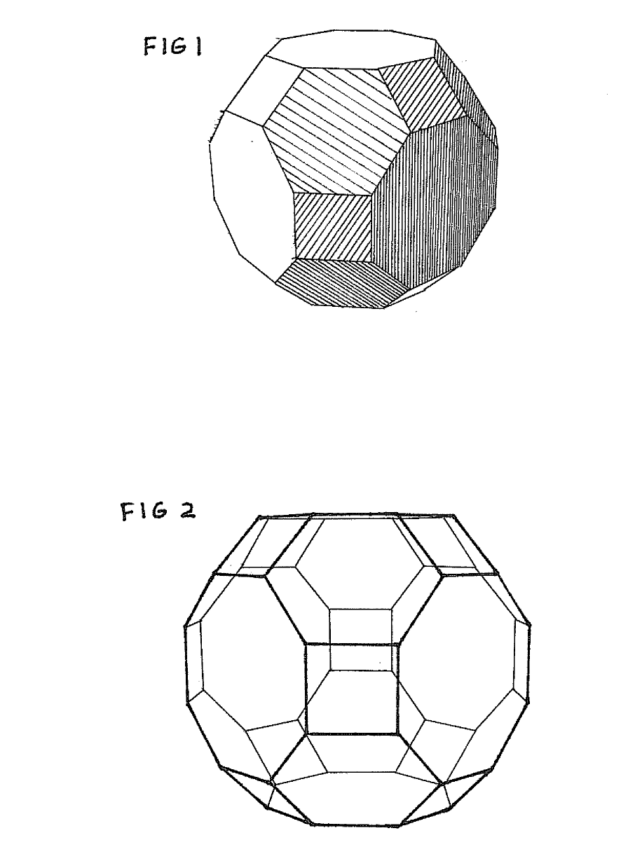

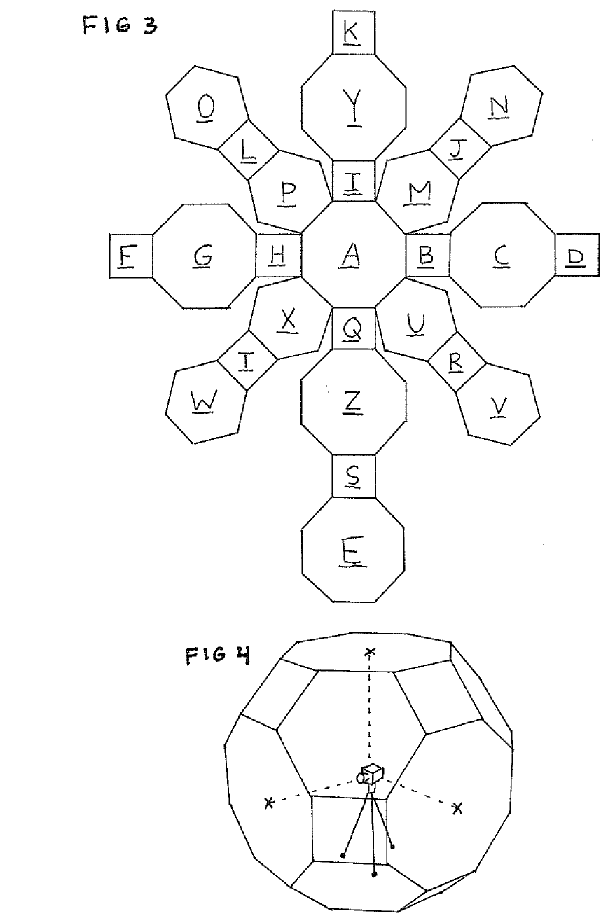

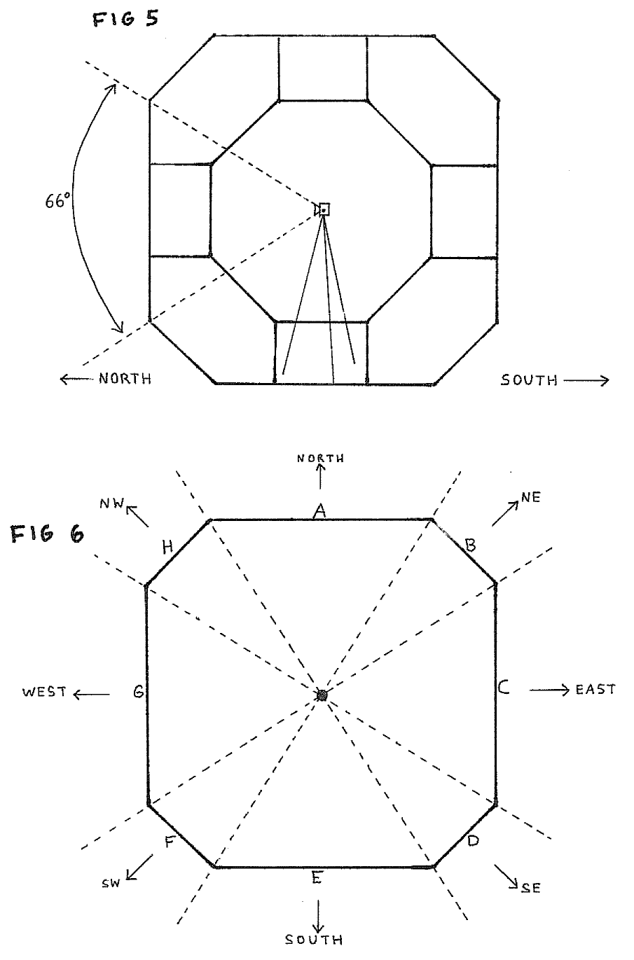

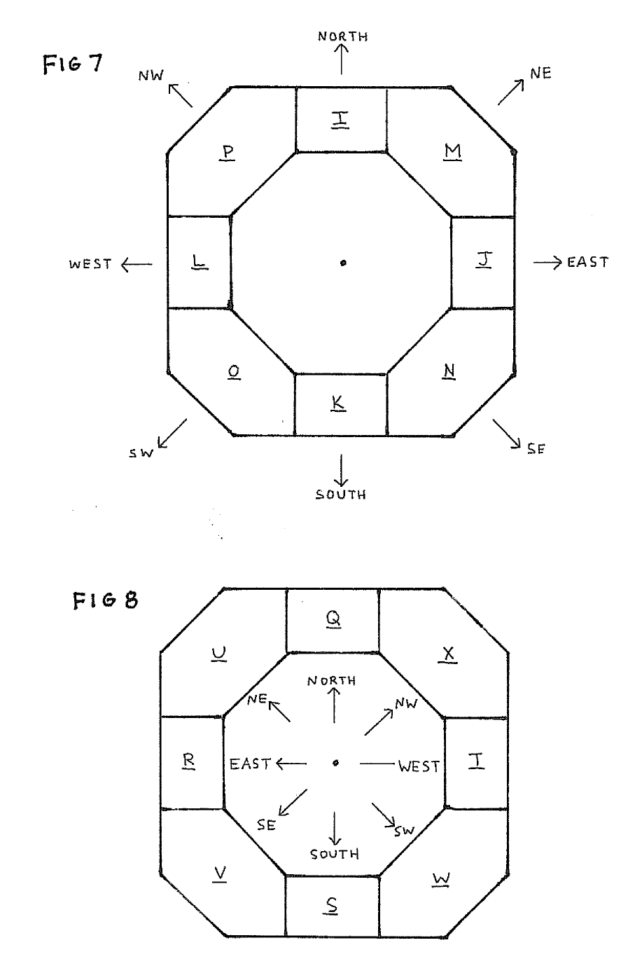

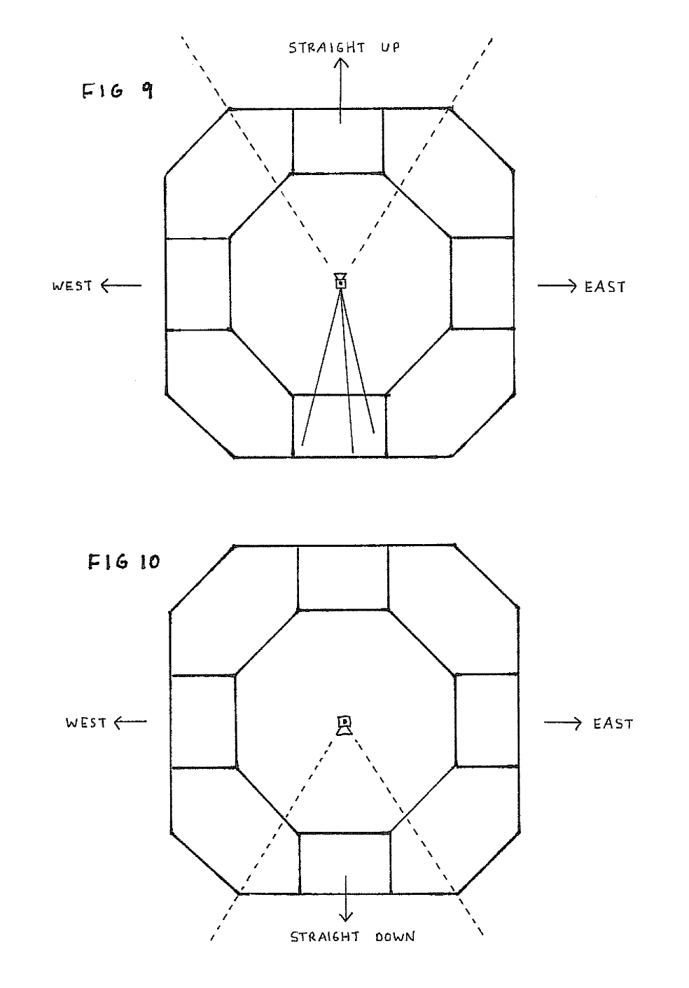

This invention is a process to take photos of the entire realm of vision from one location, and then display the photos in a precise way so that the entire realm of vision can be inspected and held in one's hand. This method requires that the photographer be very familiar with the Archimedean solid known as the “Truncated Cuboctahedron”, also called the “Great Rhombicuboctahedron” (see FIG. 1 and FIG. 2). The photographer must be familiar with the net of a Truncated Cuboctahedron, which is the flat version in FIG. 3. Each shape in FIG. 3 has been designated with a letter, A through Z, which refers to the order in which 26 photographs will be taken. In order to take 26 photos of the entire realm of vision, first the photographer must set up a tripod equipped with rotational measurements, such as degrees and angles. The photographer must imagine that the camera is situated exactly in the center of the core of a Truncated Cuboctahedron (see FIG. 4). The process of taking 26 precise directional photos can begin.

FIG. 5 is a side view of the first photo being taken. The camera (in the center) is level and pointed straight to the left, which we will call “North”. This northern photo is capturing the field of vision beyond Octagon A (see FIG. 3). The dotted lines represent the throw of the camera lens. In order to capture the field of vision beyond Octagon A, the camera lens must have a vertical throw of approximately 66 degrees. More than 66 degrees will capture too much of the field of vision in one photograph, and less than 66 degrees will capture too little.

This first photo becomes Octagon A later. The photographer rotates the camera 45 degrees clockwise, which will point the camera northeast (see FIG. 6). The photographer will take a picture from there, which will become Square B later (see FIG. 3). The photographer will keep rotating the camera 45 degrees and taking pictures until the first 8 photos are done, according to FIG. 6.

With the camera back in its original position facing north, the photographer will rotate the camera up 45 degrees (up from level is towards the sky). Taking a picture from this position will later become Square I (see FIG. 3 and FIG. 7). Rotating the camera 90 degrees clockwise will point the camera in the direction of Square J, 90 more degrees will be Square K, and 90 more degrees will be Square L. One picture must be taken at each stop, as usual. After the picture for Square L, the camera must be rotated 135 degrees clockwise so it is pointing in the northeast direction. Before this photo can be taken, the camera must be rotated down 12 degrees, so it is pointing approximately 33 degrees up from level. Now the picture for Hexagon M can be taken, and the camera can be rotated for Hexagons N, O, and P (see FIG. 7).

Returning the camera to face north, the photographer must rotate the camera down until it is pointing 45 degrees down from level (towards the ground). A photo from this position will capture the field of vision for Square Q (see FIG. 8). The photographer will rotate the camera clockwise three times for three more pictures, namely Squares R, S, and T. Note that in FIG. 8, Squares Q, R, S, and T are depicted in counter clockwise fashion. This is because the drawing is depicting an underground vantage point, which is the opposite of the aerial view in FIG. 7. After the picture for Square T, another clockwise 135 degree turn will bring the camera to face northeast (NE) for Hexagon U (FIG. 8). Since the camera is pointing down 45 degrees, the photographer must rotate the camera up about 12 degrees, so that it is approximately 33 degrees down from level, and then take the photo for Hexagon U. After that picture, three more pictures at three more 90 degree turns will capture the field of vision beyond Hexagons V, W, and X.

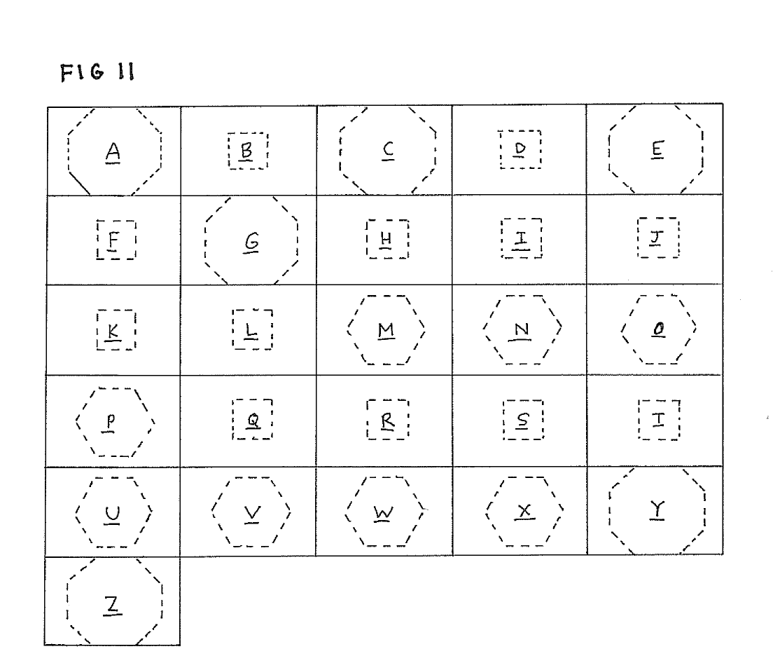

At this point the photographer has captured photos A through X, and only two more are left. The final photos are straight up and straight down. FIG. 9 depicts the camera pointed straight up to capture the field of vision beyond Octagon Y (see also FIG. 3 again). FIG. 10 depicts the camera pointing straight down to capture the field of vision beyond Octagon Z. Notice that the tripod is not depicted in FIG. 10. In order for the tripod to not appear in the photo, it is preferable to find another means of support for the camera, possibly from above or from the side. All 26 photos of the entire realm of vision are complete and can be developed.

If the photographs are developed at the standard 4 inch by 6 inch format, they can be laid on a table in sequential order as depicted in FIG. 11. A stencil of a perfect square, hexagon, and octagon can be made to trace onto the photos. Every side of every shape must be of the same length. This means that if the photos are developed at 4″×6″, then the octagon stencil is going to be the shape with the most volume. It will measure 4″ from top to bottom, giving each side a length of approximately 1⅝ inches. The hexagon and square stencil must also have side lengths of 1⅝″ also. Once the stencils are made, they can be traced onto the photographs according to FIG. 11. Special care must be taken to insure that the image from one shape is continued onto the shapes that will be placed next to it. For example, in FIG. 3, one can see that the image on the top edge of Octagon A is going to continue onto the bottom edge of Square I.

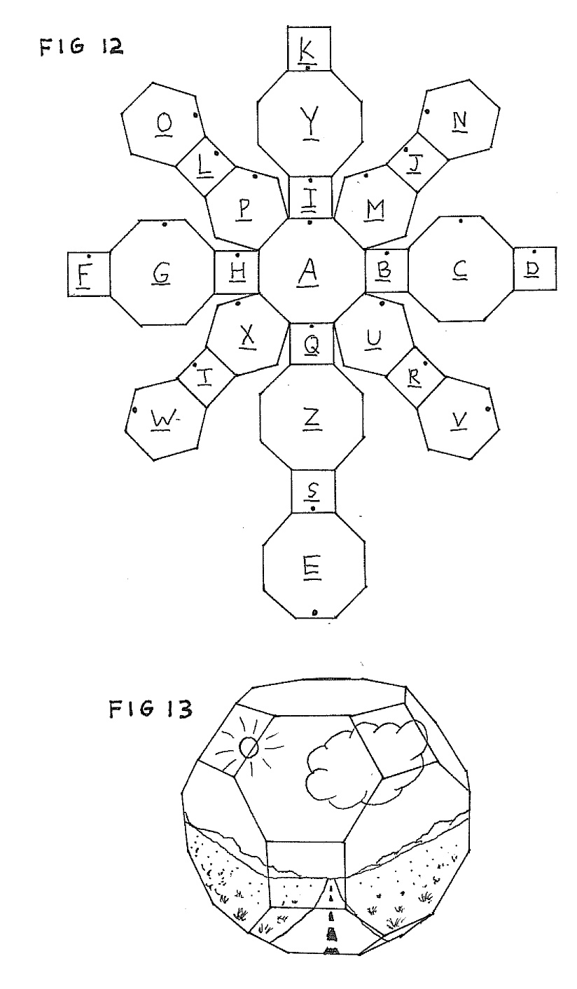

Once the shapes have all been traced onto the photos, the photos are to be cut into those shapes (FIG. 11). The shapes themselves are to be kept for the invention and every part of the photos outside the shapes are scraps and can be discarded. Special care must be taken to remember the letter of each shape and its orientation (meaning which side is up). Labeling the back of the photo prior to cutting easily does this. Once cut, FIG. 12 can be used as a guide to show how the 26 photos are to be arranged. Notice the “up” direction of each shape is indicated by a dot along the upper edge. This means that shapes E, S, and K are completely upside down in this orientation. Notice that Y and Z have no up orientation. That is because Y is a photo pointing straight up, and Z is a photo pointing straight down.

Once assembled into FIG. 12, tape can be applied on the back of the photos to join all the edges. This will allow the photos (as displayed in FIG. 12) to move as one unit. The final step is to carefully begin taping all the edges together, in order to form the three dimensional Truncated Cuboctahedron depicted in FIG. 1, FIG. 2, and FIG. 13. When the photo images are facing out, the entire realm of vision can be observed on the outside of the solid shape. I have illustrated this by drawing what a simple desert road might look like if one were standing in the middle of it. The upper half of the shape would be the sky, and the lower half would be the ground. Held in the hand, one can rotate this object and inspect the entire realm of vision from the middle of that desert road. This photographic process is possible to do in any location. This is why I have given this invention the name “The Captive Universe: a 26 Viewpoint Method to Contain Infinity”.

1. (canceled)

2. A method for capturing images of the complete field of vision around a point, so that said field of vision may be represented as images arranged according to the form of an Archimedean Solid, comprising the steps of:
a. capturing images from an adequate number of directions around a point in space,
c. reproducing said images,
d. finding visual connecting points within the reproduced images,
e. arranging the reproduced images according to the form of an Archimedean solid,
whereby the complete field of vision around a point is represented as images in the form of an Archimedean Solid.

3. The method of claim 2, wherein the Archimedean Solid is a truncated cuboctahedron, also called great rhombicuboctahedron.

4. The method of claim 2, wherein the images are captured using an apparatus which produces still images.

5. The method of claim 2, wherein the images are captured using an apparatus which produces moving images.

6. The method of claim 2, wherein the final images are represented as still images.

7. The method of claim 2, wherein the final images are represented as moving images.

8. The method of claim 2, wherein the Archimedean Solid is displayed as a flattened arrangement of its form.
